(19) United States
(12) Patent Application Publication
(10) Pub. No.: US 2006/0000957 A1
(43) Pub. Date: Jan. 5, 2006

(54) Universally positionable mounting apparatus

(76) Inventor: Jeffrey D. Carnevali, Seattle, WA (US)

Correspondence Address: Charles J. Rupnick, PO Box 46752, Seattle, WA, 98146, US

(21) Appl. No.: 10/884,182

(22) Filed: Jul. 2, 2004

(51) Int. Cl. F16B 7/04; F16M 11/02

(52) U.S. Cl. 248/181.1

(57) ABSTRACT

A mounting device having first and second couplers spaced apart along a line of juncture extending therebetween; a split arm assembly formed by first and second arm sections having sockets formed at opposite ends thereof, the sockets being structured to cooperate with the couplers; a clamping mechanism that is structured to squeeze together the first and second arm sections with the pair of couplers captured between the cooperating sockets thereof; and a third coupler secured to an external surface of one of the first and second arm sections between the opposite ends thereof.

### FIELD OF THE INVENTION

The present invention relates to a universally positionable mounting apparatus, and in particular to a ball-and-socket structured for clamping one or more resiliently deformable ball mounts within a bifurcated clamping device.

### BACKGROUND OF THE INVENTION

A universally positionable ball-and-socket mounting apparatus of the type disclosed by Carnevali in U.S. Pat. No. 5,845,885, entitled “UNIVERSALLY POSITIONABLE MOUNTING DEVICE,” issued to Jeffrey D. Carnevali on Dec. 8, 1998, which is incorporated herein by reference, is generally well known and is known to be very effective for universally positioning and immoveably supporting an otherwise relatively movable object in a substantially infinite variety of combinations of fixed angular and spatial relations to a relatively stationary object or mounting surface, with the ball-and-socket mounting apparatus oriented at variable angular orientations with respect to either or both of the supported and relatively stationary objects.

FIG. 1 is an exploded view of the ball-and-socket mounting device 1 of the prior art as disclosed by Carnevali in U.S. Pat. No. 5,845,885; FIG. 2 is a detail view of one portion of the mounting device 1; and FIG. 3 is a detail view taken from FIG. 2. The mounting device 1 is formed of a split arm assembly 3 formed of a pair of elongated, relatively rigid arm sections 7 and 9, a clamping mechanism 5 for squeezing together the pair of arm sections 7 and 9, a compression coil spring 11 for biasing apart the pair of arm sections 7, 9, and a pair of resiliently deformable ball-end mounts or “couplers” 13 and 15 with part-spherical heads 17 and 19 formed thereon, respectively, to which the split arm assembly 3 is clamped by the clamping mechanism 5 when the device 1 is put to use in mounting a relatively movable supported object on a support platform surface P in relation to a relatively stationary object or support surface S. The respective arm sections 7, 9 are identical, and are in operatively juxtaposed arrangement to one another along a line of juncture 21 extending therebetween. The respective arm sections 7, 9 have inner faces 23 thereon which are operatively opposed to one another across a plane 25 (shown in FIG. 2) coincident with the line of juncture 21; and also pairs of corresponding first and second head or “end” portions 27 and 29 thereof that are operatively opposed to one another across the plane 25. Pairs of recesses in the faces of the respective arm sections 7, 9 form pairs of operatively opposing first and second sockets 31 and 33 in the pairs of first and second heads or end portions 27, 29 of the arm sections 7, 9, respectively. The respective pairs of sockets 31, 33 have part spherical surfaces at the inner peripheries thereof, and rims 35 formed thereabout on the faces 23 of the respective arm sections. The respective rims 35 are cut away by indentations 37 and 39 formed therein. The respective pairs of sockets 31, 33 have cruciate grooves 41 formed therein at the inner peripheries thereof.

The faces 23 of the respective arm sections 7, 9 are hollowed-out by elongated lengthwise recesses 43 formed therein between the first and second sockets 31, 33 of the first and second heads or end portions 27, 29. Rounded bosses 45 are formed in the hollowed-out recesses 43 for retaining the compression coil spring 11 between the arm sections 7, 9.

Apertures 47 are formed through the respective arm sections 7, 9 at the center of bosses or lands 49 positioned midway between the first and second sockets 31, 33. Hexagonal counter-bores 51 are formed at the mouths of the apertures 47 on the outer surfaces of the arm sections 7, 9. When the pair of arm sections 7, 9 is operatively juxtaposed to one another to form the split arm assembly 3, the apertures 47 are arranged in a substantially coaxial relationship with one another and the compression coil spring 11 is interposed between the pair of rounded bosses 45 in the hollowed-out recesses 43 of the arm sections 7, 9 so as to be caged lengthwise between the pair of arm sections 7, 9 when the pair of arm sections is squeezed together by the clamping mechanism 5. The compression spring 11 yieldably biases the arm sections 7, 9 to relatively separate from one another when the clamping mechanism 5 is relaxed, and compresses between the pair of arm sections 7, 9 when the arm sections are squeezed together by the clamping mechanism 5.

The clamping mechanism 5 operates between the pair of arm sections 7, 9 along the axis 53 of the apertures 47.

The clamping mechanism 5 is formed of a bolt 55 with an elongated shank 57 that is inserted through the apertures 47 of arm sections 7, 9. A hexagonal head 59 at one end of the shank 57 is seated in the hexagonal counter-bore 51 of one arm section 7, which retains the bolt 55 against rotation. A threaded end portion 61 of the shank 57 extends through the aperture 47 in the second arm section 9 and is engaged by a washer 63 and an internally threaded knob 65 with diametrically opposing wings 67 for operation as a wing nut. The knob 65 and the bolt 55 function as the clamping mechanism 5, in that the pair of arm sections 7, 9 are squeezed together along the longitudinal axis 53 of the bolt 55 against the bias of the compression spring 11 by threading the knob 65 relatively inwardly along the length of the threaded end portion 61 of the shank 57 in the direction of the bolt head 59. The pair of arm sections 7, 9 are allowed to separate from one another by unthreading the knob 65 along the shank 57 of the bolt in the opposite direction, to allow the bias of the compression spring 11 to separate the pair of arm sections 7, 9 from one another. In both cases, because of the eccentricity of the spring 11 with respect to the axis 53 of the bolt 55, there is a differential in the reaction of the respective pairs of first and second head or end portions 27, 29 of the arm sections 7, 9 to the clamping forces generated by the clamping mechanism 5.

The ball-end mounts or couplers 13 and 15 are identical and each includes a disc-shaped base 69 and 71, respectively, with a reduced diameter stem or “neck” 73 relatively upstanding thereon, and a ball-shaped head 17, 19, respectively, upstanding in turn on the neck 73. Each ball-shaped head 17, 19 has a part spherical surface 75 (shown in FIG. 2) about the outer periphery thereof, and a relatively resiliently pressure deformable elastomeric material in the body thereof, which renders the head relatively radially compressible. The material is relatively resilient so that, when the compressive forces are released, the body of the ball-shaped heads 17, 19 resumes its original ball shaped configuration at the surfaces 75 thereof. The respective ball-shaped heads 17, 19 are sized so that the radii thereof are approximately equal to those of the inner peripheral surfaces of the sockets 31, 33, and in the operation of the device 1, the sockets 25 in the end portions 3 of the arm sections 7, 9, are engaged about the ball-shaped head 17 of the coupler 13 so as to form a ball-and-socket joint 77 (shown in FIG. 2) therebetween. That is, the inner peripheral surfaces of the sockets 25 and the part spherical surfaces 75 of the first ball-shaped head 17 are caused to substantially coincide with a first circle of revolution 83 (shown in FIG. 3) having its center at a first locus 79 of the head 17.

The inner peripheral surfaces of the sockets 26 and the part spherical surfaces 75 of the second ball-shaped head 19 are caused to substantially coincide with a second circle of revolution (not shown) having its center at a second locus 81 of the head 19.

Later in the operation of the device, the inner peripheral surfaces of the sockets 26 in the end portions 4 of the arm sections 7, 9 are caused to engage about the surfaces 75 of the ball-shaped head 19 of the coupler 15 to form a similar joint therebetween, but only that between the ball-shaped head 17 and the sockets 25 is shown in the drawings. In each case, the pressure deformable material in the body of the head 17, 19 enables the head to be squeezed between the surfaces 75 thereof to less than the diameter of the circle of revolution 83 with which the respective surfaces of the sockets 31, 33 and the ball-shaped head 17, 19 coincide. Moreover, the resiliency of the material in the body of the ball-shaped head 17, 19 enables the surfaces 75 thereof to resume coincidence with that circle when the compression on the head is released in a subsequent stage in the operation of the device.

The base 69, 71 of each respective coupler 13, 15 has multiple clearance holes 85 therein for screws (not shown) for fastening the coupler 13 to an object to be supported, hereinafter “object” (not shown), and for fastening the coupler 15 in like manner to the support surface S.

The mounting device 1 has two principal stages of operation: a first stage in which the split arm assembly 3 and the clamping mechanism 5 make a loose connection between the object and the support surface S; and a second stage in which that connection is rigidified so as to support one the object on the support surface S. Between the two stages, there is an intermediate stage in which the angular orientation of the line of juncture 21 between the pair of arm sections 7, 9 is variable with respect to either or both of the object and the support surface S, so as to vary the angular orientation of object with respect to the support surface S. The connection may be made to have sufficient rigidity at one end thereof, 3, 13, 3, moreover, that the adjustment can be made at the other end thereof, 4, 15, 4 while the rigidity of the one end 3, 13, 3 is relied on to maintain the angular orientation of the line of juncture 21 with respect to the object at the one end of the connection.

To carry out the operation, initially, the two couplers 13, 15 are secured to the object and the support surface S, respectively. The two couplers 13, 15 are also arranged so that the first and second ball-shaped heads 17, 19 are spaced apart from one another at the first and second loci 77, 81, respectively, adjacent the opposite ends of a line of juncture 21 along which the mounting device 1 is to be interposed between the object and the support surface S. This leaves part spherical surfaces 75 of the first ball-shaped head 17 disposed on opposite sides of the plane 25 (shown in FIG. 2) of the line of juncture 21, and substantially in coincidence with a first circle of revolution 83 (shown in FIG. 3) having its center at the first locus 79 of the first ball-shaped head 17. Either simultaneously with or subsequent to securing the couplers to the object relative to the support surface S, the split arm assembly 3 is arranged about the line of juncture 21 so that the pair of arm sections 7, 9 is operatively juxtaposed to one another along the line of juncture 21 between the spaced first and second loci 21 and 23 of the first and second ball-shaped heads 17, 19; and the pairs of corresponding first and second end portions 3 and 4 of the arm sections 7, 9 are operatively opposed to one another across the plane 25 of the line of juncture 21. The faces 23 of the arm sections 7, 9 are likewise operatively opposed to one another across the plane 25 of the line of juncture 21.

The compression coil spring 11 and the clamping mechanism 5 are engaged between the arm sections 7, 9 so as to hold the pair of arm sections 7, 9 together, and the knob 65 is threaded onto the threaded end portion 61 of the shank 57 of the bolt 55 and engaged sufficiently to apply initial clamping forces to the pair of arm sections 7, 9 and thereby squeeze the arm sections 7, 9 together relatively crosswise the plane 25 of the line of juncture 21. As the arm sections 7, 9 are squeezed together, the compression spring 11 produces a differential in the reaction of the respective pairs of first and second end portions 3 and 4 of the arm sections 7, 9, so that the arm sections 7, 9 assume a relatively transversely contracted disposition thereof about the first ball-shaped head 17 in which the pair of first sockets 25 is operatively engaged about the peripheral surfaces 75 of the first ball-shaped head 17 in substantial coincidence with the first circle of revolution 83. At this point in the operation, the pair of second end portions 4 of the arm sections 7, 9 is spaced apart from one another about the second ball-shaped head 19 to the extent that although the arm sections 7, 9 forms a connection between the first and second ball-shaped heads 17, 19, at the second ball-shaped head 19 the connection allows the arm sections 7, 9 to be squeezed further together about the second ball-shaped head 19. This completes the first stage in the operation of the device and inasmuch as at the conclusion of it, the pair of first sockets 25 forms a first ball and socket joint 77 (shown in FIG. 2) with the outer peripheral surfaces 75 of the first ball-shaped head 17. The first ball-shaped head 17 and the arm sections 7, 9 may be pivoted in relation to one another at the first joint 77 to position the line of juncture 21 at any angular orientation desired with respect to either or both of the object 6 and the support surface S while the first and second ball-shaped heads 17, 19 remain connected by the device 1. However, because of the differential in the reaction of the pairs of end portions 3 and 4 of the arm sections 7, 9, the connection may be made tighter at the end thereof coupled to the first head 17; and an adjustment may be made more readily at the end of the connection at the second head 19. An adjustment may be made at either end, however, and while such adjustment is being made, the connection remains intact, so that only limited assistance from an operator is needed to support the object during this intermediate stage.

When an angular orientation for the line of juncture 21 has been selected, the device 1 is put through the second stage in the operation thereof to rigidify the connection between the object and the support surface S. Accordingly, the knob 65 is further engaged with the threads 61 on the bolt shank 57 to apply additional clamping forces to the arm sections 7, 9, and to apply those forces to the extent necessary to rigidify the connection between the first and second ball-shaped heads 17, 19 at the selected angular orientation of the line of juncture 21 with respect to the object and support surface S. When the clamping mechanism 5 has completely overcome the biasing forces of the compression spring 11, then the sockets 26 in the end portions 4 of the arm sections 7, 9 are squeezed further together about the second ball-shaped head 19 at the second locus 81.

The inherent resiliency in the body of the first head 17 permits the first joint 77 to be restored if desired to enable a further adjustment to be made in the orientation of the line of juncture 21, by releasing the clamping mechanism 5 relatively crosswise the plane 25 of the line of juncture 21 until the arm sections 7, 9 and the first head 17 can be pivoted in relation to one another to a new location at which the line of juncture 21 is repositioned at a different angular orientation with respect to the object and the support surface S.

Alternatively, while the clamping mechanism is being released, the arm sections 7, 9 may be retracted in relation to one another to a “third” position of the bifurcated arm assembly 3 in which the faces 23 of the arm sections 7, 9 are sufficiently spaced apart from one another about the head 19 of the coupler 15, that the head 19 is detachable from the bifurcated arm assembly 3 and vice versa. In addition, the space between the first and second loci 77, 81 of the pair of couplers 13, 15 may be of such length, due to the length of the split arm assembly 3, that when the second head 19 is detached from the bifurcated arm assembly 3 and vice versa, the end portions 4 of the arm sections can be pinched together against the bias of the compression spring 11 to separate the pair of sockets 25 from one another to the extent that the first head 17 can be detached from the arm sections 7, 9 and vice versa.

When operatively opposed to one another, the indentations 37, formed in the rims 35 of the sockets 31, 33 form slots therebetween that are greater in width than the necks 73 of the couplers 13, 15, so that the angular orientation of the line of juncture 21 can be made to extend at right angles to the neck of either coupler, if desired, for example, by rotating the bifurcated arm assembly 3 about the head 17, 19 of the respective coupler 13, 15 until the neck 73 engages in the slot formed by the indentations. Similarly, the indentations 39 formed in the rims 35 of the sockets 31, 33 at the ends of the arm sections form “fish mouths” therebetween that are sufficiently wider than the necks 73 of the couplers 13, 15, that the bifurcated arm assembly can be rotated about a head, for example, the head 17 of the coupler 13, to an angular orientation in which the plane 25 of the line of juncture 21 extends at an oblique angle to the head.

The indentations 37, 39 and the cruciate grooves 41 in the sockets 31, 33 also provide recesses into which the bodies of the respective heads 17, 19 can deform when they are subjected to compression by the pairs of sockets 31, 33 corresponding thereto.

The respective heads 17, 19 are formed of nitrile rubber material at the surfaces 75 thereof. Other materials, including other hardened rubber and elastomer materials, may be employed. The materials are commonly given a Shore A durometer of between about 30-100 and preferably between about 60-100. Most preferable is a Shore A durometer of about between 85-90. In some versions, the heads 17, 19 have a Shore D hardness of between 40 and 70.

While supporting the object on the support surface S, the mounting device 1 operates to attenuate or “damp” transmission of mechanical vibrations between the object and support surface S, and in fact to function as a shock absorber between the two. Furthermore, the heads 17, 19 act as electrically insulative media in the combination, so that any stray current will not travel between the object and support surface S.

Another universally positionable ball-and-socket mounting apparatus of the type described by Carnevali in U.S. Pat. No. 6,561,476, “POSITIVELY-POSITIONABLE MOUNTING APPARATUS,” issued to Jeffrey D. Camevali on May 13, 2003, which is incorporated herein by reference, is also generally well known and is known to be very effective for universally positioning and immoveably supporting an otherwise relatively movable object in a substantially infinite variety of combinations of fixed angular and spatial relations to a relatively stationary object or mounting surface, with the ball-and-socket mounting apparatus oriented at variable angular orientations with respect to either one or the other of the supported and relatively stationary objects.

FIG. 4 is a detailed side view illustration of a positively-positionable positionable wheel-and-axle mounting apparatus 101 of the prior art as disclosed by Carnevali in U.S. Pat. No. 6,561,476 as substantially rigid positively-positionable wheel-and-axle mounting coupler 102 having a substantially rigid multisided stem or axle portion 103 with a substantially rigid disc-shaped button or wheel portion 105 mounted at one end. The axle portion 103 projects from a surface base 107 fixed to the support surface S. The support base 107 and the positively-positionable wheel-and-axle mounting coupler 102 projecting from it are formed of a relatively rigid material, such as a metal or hard plastic.

According to one embodiment of the invention, the axle portion 103 is formed with a convex polygon shape, having multiple flat or planar surfaces 109a, 109b, 109c through 109n. The axle portion 103 is long enough to ensure that a portion of each of a pair of arm sections 111 and 113 (shown in FIG. 7) of another split-arm assembly 114 (described below) can obtain a suitable grip between the wheel portion 105 which is sufficiently thick to support at least a minimum predetermined load applied to the split-arm assembly 114.

FIG. 5 is a cross-section view taken through the multisided axle portion 103 of the positively-positionable mounting apparatus 101 illustrated in FIG. 4. Each of the multiple surfaces 109a through 109n is rotated at substantially the same angle relative to the adjacent surfaces on either side, the angles summing to 360 degrees. According to the exemplary embodiment illustrated, the axle portion 103 has a convex polygon-shape that includes eight adjacent surfaces 109a-h. Other equivalent embodiments of the invention optionally include more or less adjacent surfaces 109a-n. However, the adjacent surfaces 109a-n are sufficiently small in number to ensure positive positioning without slipping relative to the portions of the operatively juxtaposed convex polygon-shaped socket sections of the arm sections 111, 113 which are structured to fit around the convex polygon-shaped axle portion 103. Such positive positioning is ensured primarily by a length of each of the surfaces 109a-n that is significant relative to the thickness of the multisided axle portion 103. Accordingly, the number of adjacent surfaces 109a-n is in the range of about three or four to as many as about a dozen or more.

FIG. 5 also shows an underside 115 of the disc-shaped wheel portion 105 in relation to the axle portion 103. The wheel portion 105 is formed substantially concentric with the axle portion 103, such that the two portions 103 and 105 share a common longitudinal axis A. The disc-shaped wheel portion 105 has a sufficiently large diameter relative to the thickness of the axle portion 103 to ensure that a portion of each of the arm sections 111, 113 of the split-arm assembly 114 can obtain a suitable grip to support a minimum predetermined load applied to the split-arm assembly 114.

FIG. 6 illustrates one embodiment of one of two relatively rigid arm sections 111, 113 of which the split-arm assembly 114 is formed, as disclosed in U.S. Pat. No. 6,561,476. The other arm section 113 is formed similarly to the described arm section 111. The arm sections 111, 113 are formed of a relatively rigid material, such as a metal or hard plastic. The arm section 111 is formed as a short rod which is optionally hollow except for its functional features. One functional feature is a convex polygon-shaped aperture 117 formed in an end face 119 of the arm section 111. The convex polygon-shaped aperture 117 is provided by multiple substantially planar interior wall surfaces 121a through 121n that are formed substantially perpendicularly to the end face 119. The wall surfaces 121a through 121n are formed to mate with the planar surfaces 109a through 109n of the axle portion 103 of the positively-positionable wheel-and-axle mounting platform P. Thus, each wall surface 121a through 121n is rotated from the adjacent wall surfaces at an angle substantially equal to that of the angles between the planar surfaces 109a through 109n of the axle portion 103.

The end portion 178 of the arm section 111 is formed with a thickness that is at least slightly less than the length of the planar surfaces 109a through 109n of the axle portion 103, both of which are formed with sufficient length or thickness to ensure that the end face 119 of each of the arm sections 111, 113 can support a minimum predetermined load applied to the split-arm assembly 114. An interior portion 122 of the arm section 111 is recessed or hollowed out under the end face 119 to provide a space large enough to accept the disc-shaped wheel portion 105 of the wheel-and-axle assembly 14. Thus, the end face 119 fits in the gap between the mounting base 107 and the disc-shaped wheel portion 105 of the wheel-and-axle assembly 14. The matching sizes, shapes, and angles between the interior wall surfaces 121a through 121n exterior axle surfaces 109a through 109n permit the axle portion 103 to nest within the shaped aperture 117 of the arm section 111 in each of several consecutive positively locking positions.

Another functional feature is a socket-shaped cavity 123 formed at the other end of the arm section 111 distal from the end face 119. The socket-shaped cavity 123 is formed with a substantially smooth, part hemispherical inner peripheral surface approximately the same diameter as the pressure deformable ball mount or part-spherical head 17 of the type disclosed by Carnevali in U.S. Pat. No. 5,845,885, which is incorporated herein by reference. A sector or portion of the part hemispherical socket-shaped cavity 123 at the end face of the arm section 111 is removed, for example, in a plane cutting perpendicular to the length of the arm section 111. The arm section 111 thus has the indentation 39 formed as a generally hemicircular opening in the end face opposite from the end face 119. The diameter of the hemicircular opening 39 is large enough to accept the columnar rod or neck 73 connecting the ball mount 17 to the mounting base 69, as illustrated in FIG. 7. According to one embodiment of the invention, the hemicircular opening 39 in the end face opposite from the end face 119 of the arm sections 111, 113 is large enough relative to the columnar neck 73 to permit the ball mount 17 to rotate into different angular positions relative to the arm sections 111, 113 when assembled into the split-arm assembly 114.

According to one embodiment of the invention, the part hemispherical socket-shaped cavity 123 optionally includes one or more relief or indentation 37. The one or more reliefs 37 are shown in FIG. 7 at the opposite extents of the part hemispherical socket-shaped cavity 123. Thus structured, the reliefs 37 in one arm section 111 cooperate with corresponding reliefs 37 in the other arm section 113 to provide side openings in the socket large enough to permit entry of the neck 73. Thus, the cooperating reliefs 37 in the two arm sections 111, 113 expand the original conical range of motion of the split-arm assembly 114 relative to the ball mount 17 into a fan-shaped section, as disclosed in U.S. Pat. No. 6,561,476, which is incorporated herein by reference. According to one embodiment of the invention, the cooperating reliefs 37 permit the split-arm assembly 114 to rotate within the fan-shaped section as much as +/−90 degrees or more relative to the ball mount 17.

According to one embodiment of the invention, each of the arm sections 111, 113 is also formed with the aperture 47 that is sized to pass a shoulder bolt or another equivalent threaded fastener, as described in FIG. 7. The aperture 47 is optionally surrounded by the shoulder or boss 49 that helps support the clamping force applied by the threaded clamp assembly 5 when the arm sections 111, 113 are secured together.

FIG. 7 illustrates one embodiment of the ball mount 17 by which objects are securely and fixedly mounted relative to a fixed surface by the multiply configurable support and multiply positionable mounting platform apparatus 10 of the prior art as disclosed by Carnevali in U.S. Pat. No. 6,561,476. As disclosed by Carnevali in U.S. Pat. No. 5,845,885, which is incorporated herein by reference, the ball mount or ball-shaped head 17 is formed on the neck 73 projecting from the mounting base 69. The ball mount or head 17, neck 73 and mounting base 69 together form the ball mount assembly or “coupler” 13 wherein the mounting base 69 is formed with the substantially planar platform surface P opposite from the ball head 17 and neck 73 for permanently attaching the object to be supported (object) using either mechanical fasteners through the clearance holes 85 or an adhesive bond such as a resilient adhesive pad, commonly known as a Pressure Sensitive Adhesive (PSA) 125, applied between the platform surface P and the object. The ball mount 17 is a substantially smooth, part spherical-shaped member formed of a pressure deformable, resilient elastomeric material, which renders part spherical the ball mount 17 relatively radially compressible. The ball mount 17 is structured for attachment of an external device. The pressure deformable material of which the ball mount 17 is composed permits its part-spherical shape to be deformed to conform to the internal contours of the arm sections 111, 113 when sufficient compressive pressure is applied. The pressure is applied by the threaded clamp assembly 5. The resilient nature of the material causes it to resume its original part spherically-shaped configuration when the clamp assembly 5 is released, whereby the compressive pressure is removed.

FIG. 7 illustrates assembly and operation of the multiply positionable mounting apparatus 101. Accordingly, the split-arm assembly 114 is simultaneously assembled with the ball mount or ball-shaped head 17 at one end and the positively-positionable wheel-and-axle mounting platform coupler 102 at the opposite end. The pair of rigid arm sections 111, 113 of the split-arm assembly 114 are secured together by the threaded clamp assembly 5 embodied, for example, the threaded shoulder bolt 55 and the wing nut-type knob 65. Alternatively, the clamp assembly 5 is formed with either a cam or another over-center clamp (not shown) that may include means, such as threaded means, for adjusting the clamping pressure exerted upon the rigid arm sections 111, 113.

During assembly, the pair of rigid arm sections 111, 113 are operatively juxtaposed to simultaneously form one socket section structured to fit securely around the ball-shaped head 17 and another socket section provided by the pair of convex polygon-shaped apertures 117 structured to fit securely around the positively-positionable wheel-and-axle mounting platform coupler 102. The bolt 55 and nut 65 clamp the arm sections 111, 113 securely around both the ball-shaped head 17 and the positively-positionable wheel-and-axle mounting platform coupler 102 in any of a variety of relative rotational orientations. The ball mount or ball-shaped head 17 can be oriented anywhere within a conical zone or a fan-shaped zone, and can be rotated throughout a full 360 degrees about the longitudinal axis L of the of the ball mount or ball-shaped head 17 and the cylindrical female collar 94. Simultaneously, the coupler portion C may be oriented in a fixed orientation with the positively-positionable wheel-and-axle mounting platform coupler 102 in one of several rotationally consecutive positively locking positions.

The convex polygon-shaped apertures 117 of the pair of operatively juxtaposed rigid arm sections 111, 113 cooperate to form a convex polygon-shaped collar around the positively-positionable wheel-and-axle mounting platform coupler 102 at one end of the split-arm assembly 114. The planar surfaces 109a through 109n of the axle portion 103 coordinate with the planar wall surfaces 121a through 121n of the shaped apertures 117 to orient the split-arm assembly 114 in any of the several rotationally relative positively locking positions. While the axle portion 103 is nested within the shaped apertures 117, the disc-shaped wheel portion 105 is fitted within the hollowed out socket portion 122 of the arm sections 111, 113 and captured behind the end face 119.

The socket-shaped cavities 123 of the pair of operatively juxtaposed rigid arm sections 111, 113 also coordinate to form a collar around the ball mount or ball-shaped head 17 at the other end of the split-arm assembly 114. The columnar neck 73 between the ball mount or head 17 and the mounting base 69 cooperates with the generally circular openings 39 in the pair of arm sections 111, 113 to orient the split-arm assembly 114 in any of the several relative locking positions within conical or fan-shaped zones.

The operatively juxtaposed rigid arm sections 111, 113 are clamped together by the bolt 55 passing through the respective apertures 47 and threading the nut 65 onto the bolt 55. The apertures 47 are formed with the hexagonal counter-bores 51. The hexagonal head 59 at one end of the shank 57 is seated in the hexagonal counter-bore 51 of one arm section 111, which retains the bolt 110 against rotation during tightening and loosening of the nut 65.

Clamping pressure is applied by tightening the head of bolt 55 and face of the nut 65 against outer surfaces of the respective arm sections 111, 113. The clamping pressure is thus be applied in stages. Applying the clamping pressure in stages causes the operative portions of the positively-positionable wheel-and-socket coupler 102 of the multiply positionable mounting apparatus 101 to become substantially fixed or locked in one relative rotational position, while the operative portions of the ball-and-socket structure remain loose and, therefore, relatively adjustable. The partially applied clamping pressure causes the multiple flat or planar surfaces 109a through 109n of the axle portion 103 of the positively-positionable wheel-and-socket apparatus 101 to nest with the corresponding planar wall surfaces 121a through 121n of the shaped apertures 117. The partially applied clamping pressure thus securely orients the split-arm assembly 114 relative to the support base 107.

Continued tightening of the nut 65 onto the bolt 55 increases the applied clamping pressure. The increased clamping pressure brings the inner peripheral surfaces of the socket-shaped cavities 123 into snug contact with the pressure deformable ball mount or ball-shaped head 17, such that motion of the split-arm assembly 114 relative to the mounting base 69 of the ball mount assembly or coupler 13 becomes more difficult. When forced together across the pressure deformable ball or head 17 by tightening the nut 65 onto the bolt 55, the inner peripheral surfaces of the part hemispherical socket-shaped cavities 123 are forced closer together than the unconstrained diameter of the deformable ball or head 17. Firmly tightening the nut 65 onto the bolt 55 applies sufficient clamping pressure between the cooperating socket-shaped cavities 123 and the pressure deformable ball or head 17 to deform the normally spherical shape of the ball or head 17. The split-arm assembly 114 thus interlocks the ball or head 17 in a relative angular orientation with the arm sections 111, 113 by conforming the pressure deformable ball or head 17 to the inner peripheral surfaces of the socket-shaped cavities 123. The firmly applied clamping pressure thus securely orients the split-arm assembly 114 relative to the mounting base 69 of the ball mount assembly 13. Thus deformed, the ball or head 17 is substantially immovably secured relative to the socket-shaped cavities 123 and the split-arm assembly 114.

Upon partial release of the clamping force, the ball or head 17 resiliently resumes its original part spherical-shaped configuration. In such uncompressed and part spherical condition, the ball or head 17 is again angularly and rotationally rotatable relative to the mating concavely-shaped socket surfaces 123 of the arm sections 111, 113. The ball or head 17 is optionally angularly and/or rotationally rotated to a different orientation relative to the split-arm assembly 114. The pressure is again applied by the clamp assembly 5 to the ball or head 17. The pressure again relatively radially compresses the pressure deformable elastomeric material into a shape that mates with the inner peripheral surfaces of the socket-shaped cavities 123. The ball or head 17 and the attached mounting base 69 are thereby again locked in a fixed angular and rotational orientation with the split-arm assembly 114.

FIG. 8 is another embodiment of the positively-positionable positionable wheel-and-axle mounting apparatus 101 of the prior art as disclosed by Carnevali in U.S. Pat. No. 6,561,476 having the pressure deformable ball mount or part-spherical head 17 embodied as a partial geodesic sphere 127 of the type disclosed by Carnevali in U.S. Pat. No. 6,561,476 and in U.S. Pat. No. 6,581,892, entitled “GEODESIC MOUNTING APPARATUS,” issued Jun. 24, 2003, which is incorporated herein by reference. The partial geodesic sphere 127 is a part spherical body formed of a substantially rigid material and having a surface that is formed with a plurality of discrete substantially planar, triangularly-shaped facets 129 intersecting at angular joints. Each triangular facet 129 is formed as a substantially planar surface oriented perpendicularly to a radius from a spherical center point of part-spherical geodesic sphere 127. Each triangular facet 129 is one segment of the 3-dimensional geodesic sphere 127. Geodesic sphere 127 is embodied in any number of multifaceted 3-dimensional forms. The partial geodesic sphere 127 is formed on the stem or neck 73 projected from the mounting base 69 formed with the substantially planar platform surface P. Matching facets 131 are formed on the inner surface 133 of the socket-shaped cavities 123 of the pair of operatively juxtaposed rigid arm sections 111, 113.

However, these well-known universally positionable ball-and-socket mounting apparatus are limited by the bifurcated clamping devices by which they support the otherwise relatively movable object.

### SUMMARY OF THE INVENTION

The present invention is a mounting device that overcomes limitations of the prior art by providing first and second couplers that are spaced apart along a line of juncture extending therebetween and a split arm assembly that is formed by first and second arm sections having sockets formed at opposite ends thereof, the sockets being structured to cooperate with the couplers. A clamping mechanism is structured to squeeze together the first and second arm sections with the pair of couplers captured between the cooperating sockets thereof A third coupler is secured to an external surface of one of the first and second arm sections between the opposite ends thereof.

According to another aspect of the invention, the clamping mechanism is formed of a threaded rod operating through apertures formed in the arm sections. The third coupler is formed with internal threads that mate with one end of the threaded rod, and a hexagonal or other non-round shape that is matched by a similarly non-round shape formed in an external surface of one of the arm sections surrounding the aperture formed therein for constraining the threaded rod from rotating relative to the arm section while the nut is being moved along its length. A nut with threads that mate with an end of the threaded rod, such as a wing nut or a knob having internal threads, is engaged to move along the length of the threaded rod external of the split arm assembly at the end opposite from the third coupler. Moving the nut along the threaded rod serves to squeeze the arm sections together with the sockets clamping the couplers in substantially fixed mutual rotational angular and spatial orientation. A second split arm assembly is optionally coupled in like manner to the third coupler, whereby a fourth coupler that is spaced apart form the third coupler along another line of juncture extending therebetween is clamped in substantially fixed mutual rotational, angular and spatial orientation with the third coupler when the second split arm assembly is squeezed together with the sockets formed therein clamping the third and fourth couplers therebetween.

According to another aspect of the invention, the threaded rod of the clamping mechanism is a bolt having the threaded rod formed on one face of a non-round head, and having a stem formed on the opposite face with the third coupler formed on the stem spaced away from the head. The non-round head of the bolt cooperates with the non-round shape formed in an external surface of one of the arm sections surrounding the aperture formed therein for constraining the threaded rod from rotating relative to the arm section while the nut is being moved along its length. Moving the nut along the threaded rod of the bolt serves to squeeze the arm sections together with the sockets clamping the couplers in substantially fixed mutual rotational, angular and spatial orientation.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is an exploded view of the ball-and-socket mounting device of the prior art as disclosed by Carnevali in U.S. Pat. No. 5,845,885;

FIG. 2 is a detail view of one portion of the mounting device of the prior art illustrated in FIG. 1;

FIG. 3 is a detail view of one portion of the mounting device of the prior art illustrated in FIG. 2;

FIG. 4 is a detailed side view illustration of a coupler portion of a positively-positionable positionable wheel-and-axle mounting apparatus of the prior art as disclosed by Carnevali in U.S. Pat. No. 6,561,476;

FIG. 5 is a cross-section view taken through the coupler portion of the positively-positionable positionable wheel-and-axle mounting apparatus of the prior art illustrated in FIG. 4;

FIG. 6 illustrates one embodiment of one of two relatively rigid arm sections of a split-arm assembly of the positively-positionable positionable wheel-and-axle mounting apparatus of the prior art structured for operation with the coupler portion illustrated in FIG. 4;

FIG. 7 illustrates one embodiment of the apparatus of the prior art as disclosed by Carnevali in U.S. Pat. No. 6,561,476 by which objects are securely and fixedly mounted relative to a fixed support surface;

FIG. 8 is another embodiment of the positively-positionable positionable wheel-and-axle mounting apparatus of the prior art as disclosed by Carnevali in U.S. Pat. No. 6,561,476;

FIG. 9 is an exploded view of a ball-and-socket mounting device of the present invention having the split arm assembly clamped by the clamping mechanism of the present invention;

FIG. 10 illustrates an alternative embodiment of the ball-and-socket mounting device of the present invention having the split arm assembly clamped by an alternative clamping mechanism of the present invention;

FIG. 11 is a side view illustration of one embodiment of the ball-and-socket mounting device of the present invention; and

FIG. 12 is a side view illustration of one alternative embodiment of the ball-and-socket mounting device of the present invention.

### DETAILED DESCRIPTION OF PREFERRED EMBODIMENT

In the Figures, like reference numerals indicate like elements.

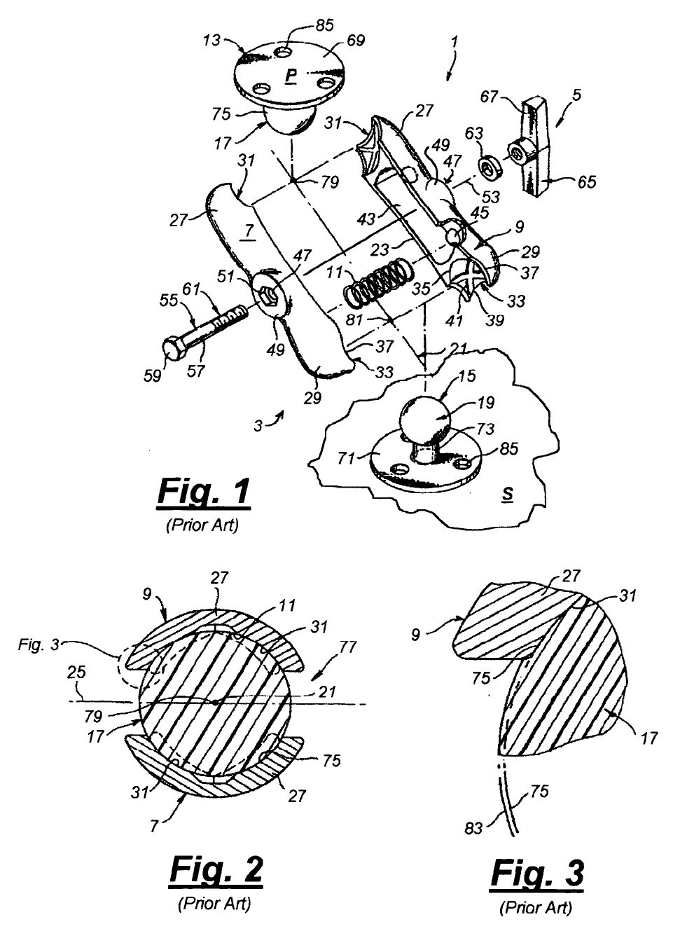

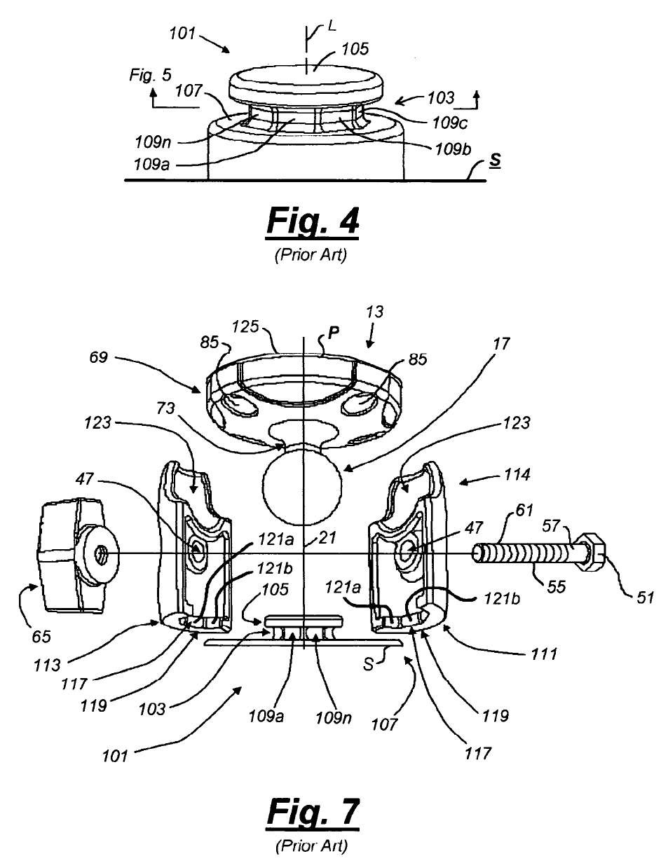

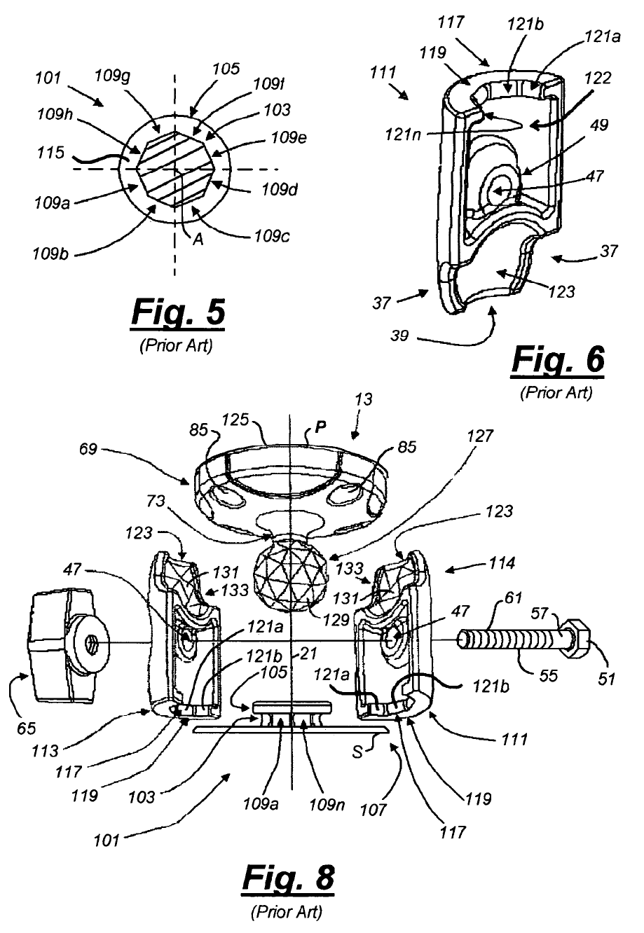

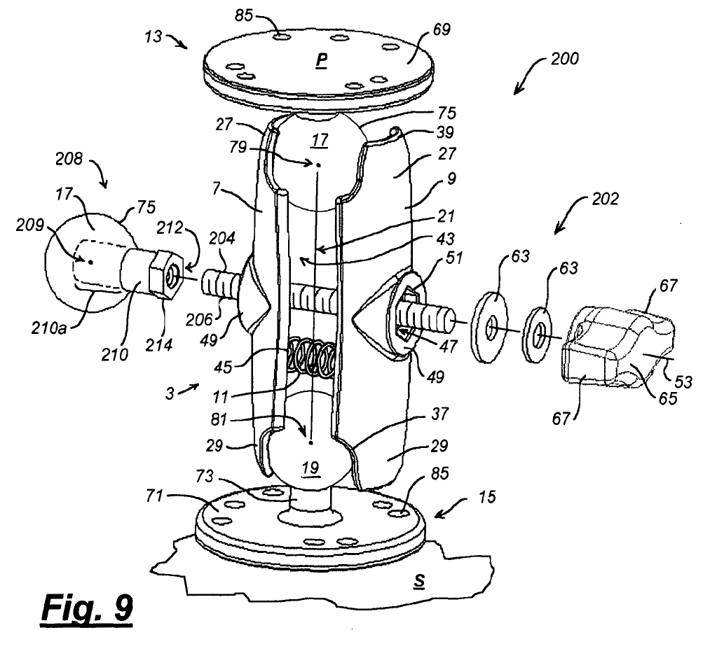

FIG. 9 is an exploded view of a ball-and-socket mounting device 200 based upon and having at its core the ball-and-socket mounting device 1 of the prior art as disclosed by Carnevali in U.S. Pat. No. 5,845,885, the complete disclosure of which is incorporated herein by reference, so that in the Figures, like reference numerals indicate like elements. The mounting device 200 is formed of the split arm assembly 3 formed of the pair of elongated relatively rigid arm sections 7 and 9, the compression coil spring 11 for biasing apart the pair of arm sections 7, 9, and the pair of resiliently deformable ball-end mounts or “couplers” 13 and 15 with the part-spherical heads 17 and 19 formed on the reduced diameter stems or “necks” 73 relatively upstanding on base 69 and 71. The split arm assembly 3 is clamped to the part-spherical heads 17 and 19 of the ball-end mounts 13, 15, respectively, by a clamping mechanism 202 of the present invention when the device 200 is put to use in mounting a relatively movable supported object on the support platform P in relation to the relatively stationary object or support surface S. The respective arm sections 7, 9 are substantially identical, and are in operatively juxtaposed arrangement to one another along a line of juncture 21 extending between the first locus 79 at the center of the head 17 and the second locus 81 at the center of the head 19. The respective arm sections 7, 9 have the inner faces 23 (shown in FIG. 1) thereon which are operatively opposed to one another across the plane 25 (shown in FIG. 2) coincident with the line of juncture 21. The respective arm sections 7, 9 also include the pairs of corresponding first and second head or “end” portions 27 and 29 thereof that are operatively opposed to one another across the plane 25, as described herein, having the pairs of recesses in the faces of which are formed the pairs of operatively opposing first and second sockets 31 and 33, respectively. The respective pairs of sockets 31, 33 include the rims 35 that are cut away by the indentations 37 and 39 formed therein. The respective pairs of sockets 31, 33 optionally include the cruciate grooves 41 formed therein at the inner peripheries thereof, as discussed herein.

The faces 23 of the respective arm sections 7, 9 are hollowed-out by the elongated lengthwise recesses 43 formed therein between the first and second sockets 31, 33 of the first and second heads or end portions 27, 29. Rounded bosses 45 are formed in the hollowed-out recesses 43 for retaining the compression coil spring 11 between the arm sections 7, 9.

The apertures 47 are formed through the respective arm sections 7, 9 at the center of the bosses or lands 49 that are positioned midway between the first and second sockets 31, 33. The hexagonal counter-bores 51 are formed at the mouths of the apertures 47 on the outer surfaces of the arm sections 7, 9. When the pair of arm sections 7, 9 is operatively juxtaposed to one another to form the split arm assembly 3, the apertures 47 are arranged in a substantially coaxial relationship with one another and the compression spring 11 is interposed between the pair of rounded bosses 45 in the hollowed-out recesses 43 of the arm sections 7, 9 so as to be caged lengthwise between the pair of arm sections 7, 9 when the pair of arm sections is squeezed together by the clamping mechanism 202 of the present invention. The compression spring 11 yieldably biases the arm sections 7, 9 to relatively separate from one another when the clamping mechanism 202 is relaxed, and compresses between the pair of arm sections 7, 9 when the arm sections are squeezed together by the clamping mechanism 202.

The clamping mechanism 202 operates between the pair of arm sections 7, 9 along the axis 53 of the apertures 47.

The clamping mechanism 202 of the present invention is formed of a threaded connector 204 embodied, by example and without limitation, as an elongated threaded rod 206 that is structured to threadedly engage and mate with the internally threaded knob 65 and sized to be inserted through the apertures 47 of arm sections 7, 9 as well as the one or more washers 63. A discrete resiliently deformable ball-end mount 208 is provided with a one of the part-spherical heads 17, 19 of the type disclosed by Carnevali in U.S. Pat. No. 5,845,885, which is formed of a resiliently deformable elastomeric material with a substantially smooth part spherical outer surface 75, as described by Carnevali in U.S. Pat. No. 5,845,885. The ball-end mount 208 has at its center the first locus 209 of, by example and without limitation, another of the ball-and-socket mounting devices 1 of the prior art as disclosed in U.S. Pat. No. 5,845,885, and is operable with such a device 1 so as to form therewith one of the ball-and-socket type joints 77.

The part-spherical ball-end mount 208 is provided, by example and without limitation, on a short substantially rigid and internally-threaded stem 210 that is structured on an extended stem portion 210a (shown in dashed) with means for fixedly retaining the elastomeric material of the ball-end mount 208 when molded over the extended stem portion 210a, such retaining means being, by example and without limitation, knurling, undercutting, shaping, serrating, and other retaining means as are well-known in the art.

The stem 210 is provided with an internally threaded longitudinal bore 212 that is structured to engage the threaded rod 206. An outer end of the stem adjacent to the threaded bore 212 is formed with a hex-shaped lip 214 sized to be received into and mate with the hexagonal counter-bore 51 at the at the center of the boss or land 49 surrounding the aperture 47 formed through either one of the respective arm sections 7, 9. The stem 210 is thus provided with means for fixing the ball-end mount 208 against rotation relative to the respective arm sections 7, 9 during threading and unthreading of the threaded knob 65 in operation.

The threaded knob 65 and the elongated threaded rod 206 function as the clamping mechanism 202 to squeeze the pair of arm sections 7, 9 together along the longitudinal axis 53 of the threaded rod 206 against the bias of the compression spring 11 by threading the knob 65 relatively inwardly along the length of the threaded rod 206 in the direction of the hex-shaped lip 214 and ball-end mount 208. The pair of arm sections 7, 9 are allowed to separate from one another by unthreading the knob 65 along the length of the threaded rod 206 in the opposite direction, to allow the bias of the compression spring 11 to separate the pair of arm sections 7, 9 from one another. In both cases, because of the eccentricity of the compression spring 11 with respect to the axis 53 of the threaded rod 206, there is a differential in the reaction of the respective pairs of first and second head or end portions 27, 29 of the arm sections 7, 9 to the clamping forces generated by the clamping mechanism 202.

The mounting device 200 has the same two principal stages of operation described U.S. Pat. No. 5,845,885 for the mounting device 1: a first stage in which the split arm assembly 3 and the clamping mechanism 202 make a loose connection between the object and the support surface S; and a second stage in which that connection is rigidified so as to support one the object on the support surface S. Between the two stages, there is also the same intermediate stage in which the angular orientation of the line of juncture 21 between the pair of arm sections 7, 9 is variable with respect to either or both of the object and the support surface S, so as to vary the angular orientation of object with respect to the support surface S. The connection may be made to have sufficient rigidity at one end thereof, 3, 13, 3, moreover, that the adjustment can be made at the other end thereof, 4, 15, 4 while the rigidity of the one end 3, 13, 3 is relied on to maintain the angular orientation of the line of juncture 21 with respect to the object at the one end of the connection.

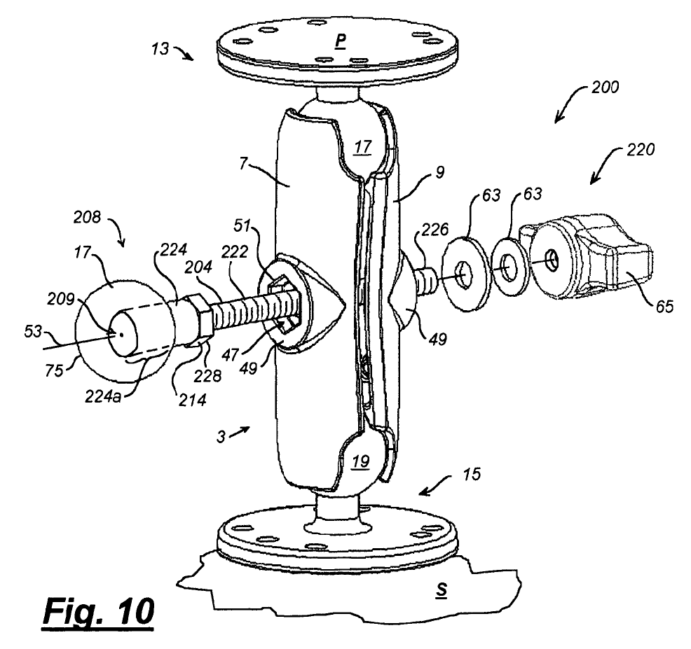

FIG. 10 illustrates an alternative embodiment of the ball-and-socket mounting device 200 of the invention having an alternative embodiment of the clamping mechanism 220 for clamping together the part-spherical heads 17 and 19 of the respective ball-end mounts 13, 15 by the split arm assembly 3. As discussed herein, the split arm assembly 3 formed of the pair of elongated relatively rigid arm sections 7 and 9, the compression coil spring 11 for biasing apart the pair of arm sections 7, 9, and the pair of resiliently deformable ball-end mounts or “couplers” 13 and 15 with the part-spherical heads 17 and 19. The split arm assembly 3 is clamped to the part-spherical heads 17 and 19 of the ball-end mounts 13, 15, respectively, by the alternative clamping mechanism 220 of the present invention when the device 200 is put to use in mounting a relatively movable supported object on the support platform P in relation to the relatively stationary object or support surface S.

The clamping mechanism 220 operates between the pair of arm sections 7, 9 along the axis 53 of the apertures 47.

The clamping mechanism 220 of the present invention is formed of the threaded connector 204 which is embodied, by example and without limitation, as an elongated threaded bolt 222 that is structured to threadedly engage and mate with the internally threaded knob 65 and sized to be inserted through the apertures 47 of arm sections 7, 9 as well as the one or more washers 63. The discrete resiliently deformable ball-end mount 208 is provided with a one of the part-spherical heads 17, 19 of the type disclosed by Carnevali in U.S. Pat. No. 5,845,885, which is formed of a resiliently deformable elastomeric material with a substantially smooth part spherical outer surface 75, as described by Carnevali in U.S. Pat. No. 5,845,885. As discussed herein, the ball-end mount 208 has at its center the first locus 209 of, by example and without limitation, another of the ball-and-socket mounting devices 1 of the prior art as disclosed in U.S. Pat. No. 5,845,885, and is operable with such a device 1 so as to form a ball-and-socket joint 77 therewith.

The part-spherical ball-end mount 208 is provided, by example and without limitation, on an extended stem portion 224a (shown in dashed) of a short substantially rigid stem portion 224 of the bolt 222, the extended stem portion 224a being formed with one of the well-known means for fixedly retaining the elastomeric material of the ball-end mount 208 when molded over the extended stem portion 224a, as discussed herein.

The bolt 222 is provided with a threaded longitudinal shaft or shank 226 that is structured to engage the internally threaded knob 65. A head portion 228 of the bolt 222 adjacent to the threaded shank 226 includes the stem portion 224 that is formed adjacent to the shank 226 with the hex-shaped lip 214 that is sized to be received into and mate with the hexagonal counter-bore 51 at the at the center of the boss or land 49 surrounding the aperture 47 that is formed through either one of the respective arm sections 7, 9. The threaded connector 204 is thus provided with means for fixing the ball-end mount 208 against rotation relative to the respective arm sections 7, 9 during threading and unthreading of the threaded knob 65 in operation.

The threaded knob 65 and the elongated threaded bolt 222 function as the clamping mechanism 220 to squeeze the pair of arm sections 7, 9 together along the longitudinal axis 53 of the threaded shank 226 against the bias of the compression spring 11 by threading the knob 65 relatively inwardly along the length of the threaded shank 226 in the direction of the hex-shaped head 228 and ball-end mount 208. The pair of arm sections 7, 9 are allowed to separate from one another by unthreading the knob 65 along the length of the threaded shank 226 in the opposite direction, to allow the bias of the compression spring 11 to separate the pair of arm sections 7, 9 from one another. In both cases, because of the eccentricity of the spring 11 with respect to the axis 53 of the threaded shank 226, there is a differential in the reaction of the respective pairs of first and second head or end portions 27, 29 of the arm sections 7, 9 to the clamping forces generated by the clamping mechanism 220.

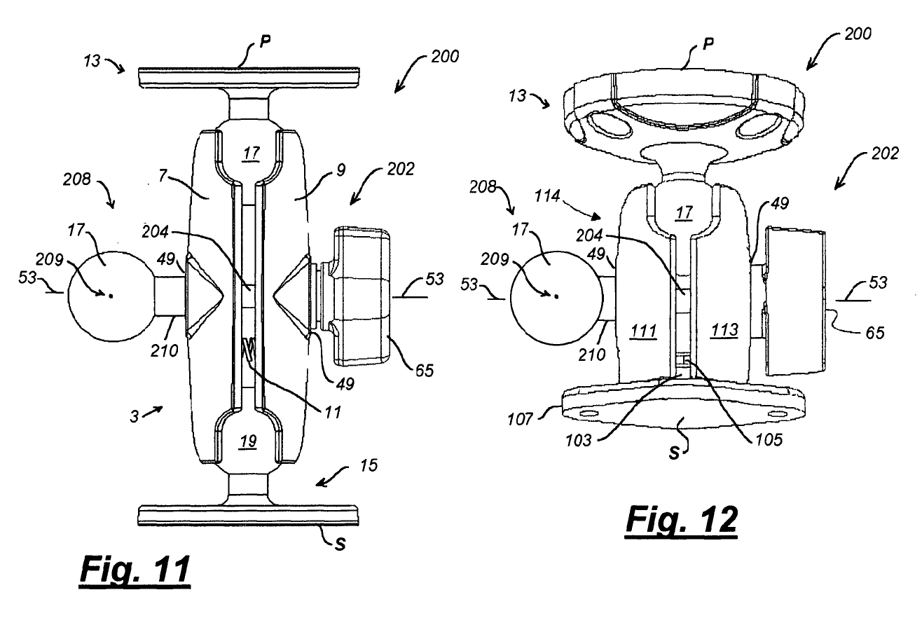

FIG. 11 is a side view illustration of the ball-and-socket mounting device 200 of the present invention based upon and having at its core the ball-and-socket mounting device 1 of the prior art as disclosed by Carnevali in U.S. Pat. No. 5,845,885. Accordingly, the ball-and-socket mounting device 200 of the present invention is illustrated having the pair of elongated arm sections 7 and 9 of the split arm assembly 3 squeezed together by the clamping mechanism 202 of the present invention operating between along the axis 53 of the threaded connector 204 and the apertures 47. The clamping mechanism 202 being formed by the threaded connector 204 having the discrete resiliently deformable ball-end mount 208 threadedly engaged therewith at one end and with one or more washers 63 and the internally threaded knob 65 engaged at the opposite end.

FIG. 12 illustrates the ball-and-socket mounting device 200 of the present invention based upon and having at its core the positively-positionable positionable wheel-and-axle mounting apparatus 101 of the prior art as disclosed by Carnevali in U.S. Pat. No. 6,561,476 having the pair of arm sections 111, 113 of the split-arm assembly 114 clamped around the multisided stem or axle portion 103 of the positively-positionable wheel-and-axle mounting coupler 102 projecting from the base 107 that is fixed to the support surface S and the resiliently deformable part-spherical head 17 on the base 69 having the support platform P for mounting the relatively movable supported object (object). According to one embodiment of the present invention, the part-spherical head 17 is alternatively embodied as the substantially rigid partial geodesic sphere 127 the plurality of discrete substantially planar, triangularly-shaped facets 129 formed on its surface, and the inner surface of the socket-shaped cavities 123 of the arm sections 111 and 113 of the split-arm assembly 114 are formed with the matching facets 131.

The arm sections 111, 113 of the split-arm assembly 114 are squeezed together by the clamping mechanism 202 of the present invention operating between along the axis 53 of the threaded connector 204 and the apertures 47. The clamping mechanism 202 being formed by the threaded connector 204 having the discrete resiliently deformable ball-end mount 208 threadedly engaged therewith at one end and with one or more washers 63 and the internally threaded knob 65 engaged at the opposite end.

While the preferred embodiment of the invention has been illustrated and described, it will be appreciated that various changes can be made therein without departing from the spirit and scope of the invention. For example, the hexagonal counter-bore 51 at the at the center of the boss or land 49 surrounding the aperture 47 and the mating lip 214 or head 228 portions of the threaded connector 204 are alternatively formed with cooperating octagonal, square, star or other mating shapes as are known in the art. Alternatively, a lock washer or other means for locking the threaded connector 204 are provided between the ball mount 17 and the shoulder or boss 49, whereby the counter-bore 51 surrounding the aperture 47 and the mating lip 214 or head 228 portions of the threaded connector 204 are eliminated. Additionally, the stem portion 210 of the part-spherical ball-end mount 208 is integrated with the shoulder or boss 49 on the outer surface of one of the appropriate arm sections 7, 111, whereby the ball mount 17 is prohibited from rotating relative to the arm section 7, 111. For example, the stem portion 210 of the ball-end mount 208 is welded, soldered, brazed, or otherwise fused to the shoulder or boss 49. Alternatively, the stem portion 210 is integrally formed with the shoulder or boss 49 on the outer surface of one of the appropriate arm sections 7, 111 during a casting, molding, matching or other integral manufacturing process; and the elongated threaded connector 204 is engaged with the internally threaded longitudinal bore 212 that is structured to engage the threaded rod 206. Alternatively, the threaded rod 206 is formed integrally with an inside surface of the arm section 7, 111 along the axis 53 of the aperture 47 in the opposing arm section 9, 113. Furthermore, the knob 65 is alternatively formed with a rounded “wheel” or cut “gear” shape or another shape convenient for finger or hand operation, as is known in the art. According different embodiments of the present invention, each of the embodiments is optionally practiced using the different couplers 17, 19 and 102 and 127 with an appropriate one of the different pairs of arm sections 7, 9 and 111, 113, as discussed herein. Thus, according to one embodiment of the present invention, one or both of the two ball mounts 17, 19 is formed as the partial geodesic sphere 127 of the type disclosed by Carnevali in U.S. Pat. No. 6,561,476 and in U.S. Pat. No. 6,581,892, and the inner faces 23 of the pairs of operatively opposing first and second sockets 31 and 33 of the respective arm sections 7, 9 are formed with the matching facets 131. Therefore, the inventor makes the following claims.

What is claimed is:

1. A mounting device, comprising:
first and second couplers;
first and second arm sections each having first and second opposite ends formed with respective recesses in one face thereof, the recesses in the first ends forming a first socket structured to cooperate with the first coupler and the recesses in the second ends forming a first socket structured to cooperate with the second coupler;
a linear clamping mechanism operating between the first and second arm sections; and
a third coupler projected from an external surface of one of the first and second arm sections.

2. The device of claim 1 wherein the third coupler is aligned with an operational axis of the linear clamping mechanism.

3. The device of claim 2 wherein each of the first and second arm sections further comprises an aperture formed therethrough along the operational axis of the linear clamping mechanism; and
wherein the linear clamping mechanism further comprises: a threaded rod having one end coupled to the third coupler, a threaded shank passing through the apertures in the first and second arm sections, and an internally threaded member positioned external of the first and second arm sections opposite from the third coupler, the internally threaded member being operable along the threaded shank for squeezing together the first and second arm sections relative to the first and second couplers.

4. The device of claim 3 wherein one of the first and second further comprises a shaped counter-bore adjacent to the aperture and an external surface of the arm section, and the third coupler further comprises a lip portion that is structured to mate with the counter-bore.

5. The device of claim 4 wherein the stem portion of the third coupler further comprises an internally threaded bore that is structured to threadedly engage one end of the threaded shank.

6. The device of claim 4 wherein the stem portion of the third coupler further comprises a head portion of a bolt that further comprises the threaded shank.

7. The device of claim 4 wherein the third coupler further comprises a stem having formed on one end thereof a part-spherical head of a resiliently deformable material and having formed on an opposite end from the part-spherical head the lip portion that is structured to mate with the counter-bore.

8. The device of claim 4 wherein one of the first and second couplers further comprises a part-spherical head of a resiliently deformable material formed on a stem projected from a base.

9. The device of claim 8 wherein an other one of the first and second couplers further comprises an other part-spherical head of a resiliently deformable material formed on a stem projected from a base.

10. The device of claim 8 wherein an other one of the first and second couplers further comprises a substantially rigid partial geodesic sphere.

11. The device of claim 8 wherein an other one of the first and second couplers further comprises a substantially rigid positively-positionable wheel-and-axle mounting coupler.

12. A mounting device, comprising:
first and second couplers spaced apart along a line of juncture extending therebetween;
a split arm assembly formed by first and second arm sections having sockets formed at opposite ends thereof, the sockets being structured to cooperate with the couplers;
a clamping mechanism that is structured to squeeze together the first and second arm sections with the pair of couplers captured between the cooperating sockets thereof; and
a third coupler secured to an external surface of one of the first and second arm sections between the opposite ends thereof.

13. The device of claim 12 wherein the clamping mechanism further comprises an elongated threaded rod extended between the first and second arm sections, the threaded rod having the third coupler coupled to a first end thereof and a threaded member engaged to a second end thereof opposite from the first end and positioned externally of the split arm assembly.

14. The device of claim 13 wherein each of the first and second arm sections further comprises an aperture formed therein between the opposite ends thereof, the apertures being aligned along a common axis and being structured as clearance holes for passing the elongated threaded rod of the clamping mechanism therethrough, the elongated threaded rod of the clamping mechanism being positioned within the apertures formed in the arm sections.

15. The device of claim 14 wherein the third coupler further comprises an internally threaded bore that is structured to engage the first end of the threaded rod.

16. The device of claim 15 wherein the third coupler further comprises a substantially rigid stem having the threaded bore formed in a first end thereof.

17. The device of claim 16 wherein the third coupler further comprises a part-spherical head formed of a resiliently deformable elastomeric material coupled to a second end of the stem opposite from the first end thereof having the threaded bore formed therein, and the stem having a anti-rotating means formed adjacent to the threaded bore, the anti-rotating means structured to cooperate with the one of the first and second arm sections for constraining the part-spherical head from rotating relative to the arm section.

18. The device of claim 17 wherein the anti-rotating means further comprises a non-round shaped counter-bore formed in an external surface of the arm section adjacent to the aperture formed therein, and a cooperating non-round shaped lip portion of the stem formed adjacent to the threaded bore.

19. The device of claim 14 wherein the elongated threaded rod of the clamping mechanism further comprises a bolt having a non-round head, an elongated threaded shank extending on a first side of the head, and a stem extending on a second side of the head opposite from the threaded shank, the third coupler being formed on a portion of the stem spaced away from the head; and
one of the first and second arm sections of the split arm assembly further comprises a counter-bore formed in an external surface of the arm section adjacent to the aperture formed therein, the counter-bore being formed with a shape that is structured to cooperate with the head of the bolt for constraining the threaded rod from rotating relative to the arm section.

20. The device of claim 19 wherein the third coupler further comprises a part-spherical head formed of a resiliently deformable elastomeric material coupled to the stem.

21. A mounting device, comprising:
first and second couplers, the first coupler being structured for being fixed to a support surface, and the second coupler being structured for being fixed to an external object to be supported relative to the support surface;
a split arm assembly having first and second arm sections with first and second end portions and an aperture therethrough that is arranged between the first and second end portions, the first and second arm sections being structure such that, when in operatively juxtaposed arrangement to one another along a line of juncture with the aperture aligned along a common axis, the first and second end portions are structured to engage the respective first and second couplers in relative angular and spatial relationship; and
a clamping mechanism structured for operating along the common axis of the apertures in the first and second arm sections for clamping the first and second couplers between the respective first and second end portions of the first and second arm sections, the clamping mechanism comprising:
a threaded connector structured for operating through the apertures in the first and second arm sections along the common axis,
a discrete ball-end mount coupled to a first end of the threaded connector and having a part-spherical head formed of a resiliently deformable elastomeric material with a substantially smooth part spherical outer surface, and
a threaded nut structured to threadedly engage a second end of the threaded connector opposite from the ball-end mount.

22. The device or claim 21, further comprising a compression spring between the first and second arm sections for biasing the end of the first and second arm sections to separate.

23. The device or claim 21 wherein the aperture of one of the first and second arm sections is structured with a counter-bore adjacent an external surface of the arm section, and the clamping mechanism is structured to engage the counter-bore in a relatively non-rotational manner.

24. The device or claim 23 wherein the threaded connector further comprises an elongated threaded rod, and the ball-end mount further comprises a substantially rigid stem that is structured to threadedly engage the first end of the threaded connector.

25. The device or claim 24 wherein the counter-bore adjacent an external surface of the arm section further comprises a non-round shaped counter-bore, and wherein the stem portion of the ball-end mount further comprises a non-round shaped male portion that is structured to cooperate with the non-round shaped counter-bore to retain the ball-end mount in a non-rotational manner relative to the arm section.

26. The device or claim 23 wherein the threaded connector further comprises a bolt having a head portion formed at one end of an elongated threaded rod, the head portion being structured at a first end adjacent to the threaded rod to engage the counter-bore in a relatively non-rotational manner and being further structured at a second end opposite from the elongated threaded rod to retain the ball-end mount in a relatively non-rotational manner.
